(19) United States
(12) Patent Application Publication
(10) Pub. No.: US 2026/0369823 A1
(43) Pub. Date: Nov. 19, 2026

(54) BATTERY CELL INTERCONNECT SUPPORT ASSEMBLIES

(71) Applicant: GM GLOBAL TECHNOLOGY OPERATIONS LLC, Detroit, MI (US)

(72) Inventors: Ekanth Ramesh, Troy, MI (US); Ryan Bledsoe, Madison Heights, MI (US); Anthony Michael Coppola, Rochester Hills, MI (US)

(21) Appl. No.: 19/208,120

(22) Filed: May 14, 2025

(51) Int. Cl. H01M 50/526; H01M 50/204; H01M 50/569; H01M 50/588

(52) U.S. Cl. CPC H01M 50/526; H01M 50/569; H01M 50/588; H01M 50/204

(57) ABSTRACT

An interconnect board includes a current collector layer having a first portion configured to connect to a first battery cell of a battery module, a second portion configured to connect to a second battery cell of the battery module, and a third portion between the first portion and the second portion. The first portion and the second portion extend in a first plane and the third portion extends in a second plane different than the first plane. The interconnect board further includes a first adhesive layer disposed on the current collector layer, an electrically isolating layer disposed on the first adhesive layer, and a second adhesive layer disposed on the electrically isolating layer and configured to connect to a shear plate of the battery module. Other example interconnect boards and battery modules are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cell interconnect support assemblies, and more particular to battery cell interconnect support assemblies for low-profile structural battery packs.

Electric vehicles, such as battery electric vehicles, hybrid vehicles, and/or fuel cell vehicles, include one or more electric machines and a battery system having one or more battery cells, modules, and/or packs. For example, the battery system may be a rechargeable energy storage system including one or more high voltage battery packs each having a collection of battery cells. Interconnect boards with injection molded frames may be employed to connect between the battery cells in a battery pack. The interconnect boards enable cell monitoring or sensing in the battery pack.

### SUMMARY

An interconnect board for connecting between a plurality of battery cells of a battery module, includes a current collector layer including a first portion configured to connect to a first battery cell of the battery module, a second portion configured to connect to a second battery cell of the battery module, and a third portion between the first portion and the second portion. The first portion and the second portion extend in a first plane and the third portion extends in a second plane different than the first plane. The interconnect board further includes a first adhesive layer disposed on the current collector layer, an electrically isolating layer disposed on the first adhesive layer, and a second adhesive layer disposed on the electrically isolating layer and configured to connect to a shear plate of the battery module.

In other features, the third portion of the current collector layer extends between the first battery cell and the second battery cell.

In other features, the interconnect board further includes an upper flexible film layer and a lower flexible film layer disposed on opposing sides of the current collector layer.

In other features, the upper flexible film layer, the lower flexible film layer, and the current collector layer are laminated together.

In other features, the interconnect board further includes a flexible film layer disposed between the current collector layer and the first battery cell and the second battery cell of the battery module.

In other features, the first adhesive layer is configured to self-level on the current collector layer.

In other features, an adhesion strength of the second adhesive layer is less than an adhesion strength of the first adhesive layer.

In other features, the interconnect board further includes a third adhesive layer disposed between the first portion of the current collector layer and the first battery cell of the battery module, and between the second portion of the current collector layer and the second battery cell of the battery module.

In other features, an adhesion strength of the third adhesive layer is less than the adhesion strength of the first adhesive layer and greater than the adhesion strength of the second adhesive layer.

In other features, the interconnect board has a width of less than 3.5 mm.

In other features, the current collector layer forms a Z stack configuration with the plurality of battery cells of the battery module.

A battery module for a vehicle, includes a plurality of battery cells including at least a first battery cell and a second battery cell, and an interconnect board for connecting between the plurality of battery cells. The interconnect board includes a current collector layer including a first portion connected to the first battery cell, a second portion connected to the second battery cell, and a third portion between the first portion and the second portion. The third portion extends in a plane different than the first portion and the second portion. The interconnect board further includes an electrically isolating layer configured to isolate the plurality of battery cells, a first adhesive layer disposed between the current collector layer and the electrically isolating layer, a second adhesive layer disposed on a side of the electrically isolating layer opposing the first adhesive layer, and a third adhesive layer disposed between the first portion of the current collector layer and the first battery cell of the battery module and between the second portion of the current collector layer and the second battery cell of the battery module.

In other features, the interconnect board further includes a shear plate connected to the second adhesive layer, wherein the shear plate and the second adhesive layer are configured to deform in response to an applied force without damaging the plurality of battery cells.

In other features, the first adhesive layer is configured to self-level on the current collector layer.

In other features, the interconnect board further includes an upper flexible film layer and a lower flexible film layer disposed on opposing sides of the current collector layer. The upper flexible film layer, the lower flexible film layer, and the current collector layer are laminated together.

In other features, the interconnect board further includes a flexible film layer disposed between the current collector layer and the first battery cell and the second battery cell of the battery module.

In other features, an adhesion strength of the second adhesive layer is less than an adhesion strength of the first adhesive layer.

In other features, an adhesion strength of the third adhesive layer is less than the adhesion strength of the first adhesive layer and greater than the adhesion strength of the second adhesive layer.

In other features, the interconnect board has a width of less than 3.5 mm.

A battery module for a vehicle, includes a plurality of battery cells including at least a first battery cell and a second battery cell, an upper shear plate and a lower shear plate disposed on opposing sides of the plurality of battery cells, and an interconnect board for connecting between the plurality of battery cells. The interconnect board includes a current collector layer including a first portion connected to the first battery cell, a second portion connected to the second battery cell, and a third portion extends between the first battery cell and the second battery cell, an electrically isolating layer configured to isolate the plurality of battery cells, a first adhesive layer disposed between the current collector layer and the electrically isolating layer, a second adhesive layer disposed between the electrically isolating layer and the upper shear plate, and a third adhesive layer disposed between the first portion of the current collector layer and the first battery cell of the battery module and between the second portion of the current collector layer and the second battery cell of the battery module. An adhesion strength of the second adhesive layer is less than an adhesion strength of the first adhesive layer. An adhesion strength of the third adhesive layer is less than the adhesion strength of the first adhesive layer and greater than the adhesion strength of the second adhesive layer.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example interconnect board for connecting between battery cells, according to the present disclosure;

FIG. 2 is a block diagram of an example battery module including the interconnect board of FIG. 1, according to the present disclosure;

FIG. 3 is an exploded perspective view of an example interconnect board assembly, according to the present disclosure;

FIG. 4 is a block diagram of another example interconnect board for connecting between battery cells, according to the present disclosure;

FIG. 5 is an exploded perspective view of another example interconnect board assembly, according to the present disclosure;

FIG. 6 is a top view of an example battery module, according to the present disclosure;

FIGS. 7-8 are sides views of the battery module of FIG. 6 showing a load transfer scenario and a failsafe scenario when different loads are applied to the battery module, according to the present disclosure;

FIG. 9 is a vehicle including a battery module, according to the present disclosure; and

FIG. 10 is a flow chart of an example process for manufacturing an interconnect board stack, according to the present disclosure.

In the drawings, reference numbers may be reused to identify similar and/or identical elements.

### DETAILED DESCRIPTION

Electric vehicles, such as battery electric vehicles, hybrid vehicles, and/or fuel cell vehicles, include a battery system having one or more high voltage battery packs each having a collection of battery cells. Interconnect boards with injection molded frames are often employed to connect between the battery cells in a battery pack and enable cell monitoring or sensing. However, such interconnect boards are often thick, heavy and rigid due to the injection molded frames. Additionally, in many cases, the interconnect boards experience warpage (e.g., distortion, deformation, etc.) in the injection molded frames due to, for example, uneven cooling. This leads to an unreliable design for geometric dimensioning and tolerancing (GD&T).

The interconnect boards according to the present disclosure provide a low-profile design leveraging a unique current collector layer along with different adhesive layers, as further explained below. With this low-profile design, the interconnect boards provide significant packaging, mass, and GD&T advantages over conventional interconnect boards. Such advantages may be crucial for vehicles, such as high-performance low-profile cars vehicles. Additionally, due to the low-profile interconnect board design, the total height of a rechargeable energy storage system (RESS) in electric vehicles is reduced while also providing stabilization to shear plates via high strength bond surfaces as further explained herein. Further, due to the different adhesive layers, a staged separation of assemblies including the interconnect boards may be achieved based on intrusion severity.

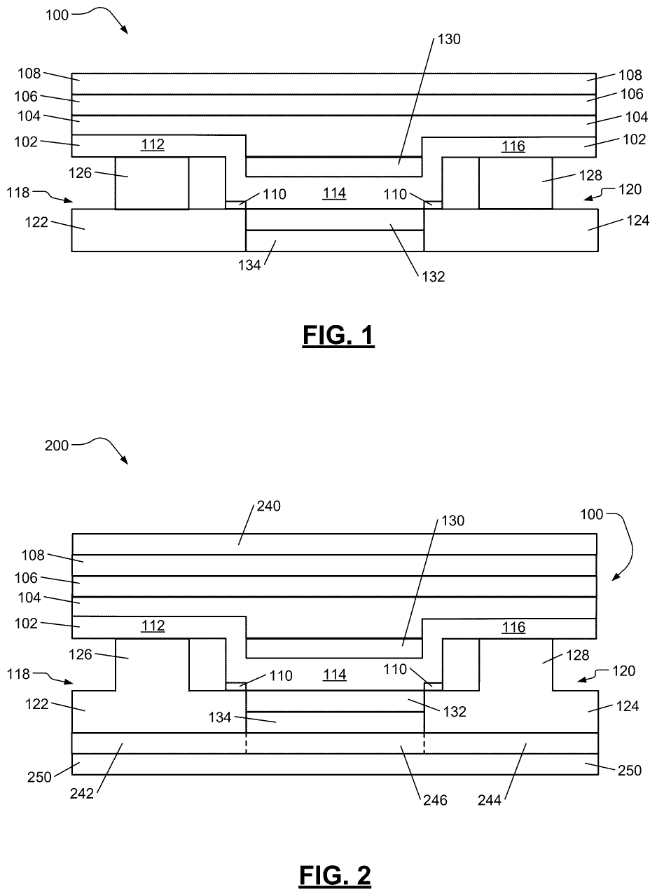

Referring now to FIG. 1, a block diagram of an example interconnect board 100 is presented for providing cell monitoring in a battery management system (BMS). The interconnect board 100 of FIG. 1 may represent a portion of larger interconnect board. As shown in FIG. 1, the interconnect board 100 generally includes a current collector layer 102, an adhesive layer 104 disposed on the current collector layer 102, an electrically isolating layer 106 disposed on the adhesive layer 104, and an adhesive layer 108 disposed on the electrically isolating layer 106.

The current collector layer 102 includes multiple portions. For example, the current collector layer 102 includes portions 112, 114, 116 each extending in a longitudinal direction. In this example, the portion 114 (e.g., a middle portion) extends between the portions 112, 116 (e.g., outer portions). The portions 112, 114, 116 are connected together via portions extending generally traverse to the portions 112, 114, 116. In various embodiments, the current collector layer 102 may be integrally formed as a single piece.

The outer portions 112, 116 of the current collector layer 102 connect with different battery cells 118, 120 of a battery module or pack. For example, each battery cell 118, 120 includes a body 122, 124 and a rivet 126, 128 extending from the body 122, 124. In FIG. 1, the rivets 126, 128 and top portions of the battery cells 118, 120 form positive terminals of the battery cells 118, 120 while outer casings or outer sides of the bodies 122, 124 (e.g., can bodies) form negative terminals of the battery cells 118, 120. As shown, the outer portion 112 of the current collector layer 102 connects to the battery cell 118, and more specifically to the rivet 126 (or positive terminal) of the battery cell 118. Likewise, the outer portion 116 of the current collector layer 102 connects to the battery cell 120, and more specifically to the rivet 128 (or positive terminal) of the battery cell 118.

As shown in FIG. 1, the middle portion 114 extends in a different plane than the outer portions 112, 116. For example, in FIG. 1, the portions 112, 114, 116 extend in parallel planes. However, the middle portion 114 extends in a plane offset from the outer portions 112, 116. More specifically, the middle portion 114 extends in a plane positioned below the outer portions 112, 116. In other words, the portions 112, 114, 116 generally form a square wave configuration with the outer portions 112, 116 having a higher amplitude than the middle portion 114. With this arrangement, the middle portion 114 of the current collector layer 102 extends between the battery cells 118, 120, as shown in FIG. 1.

In various embodiments, the current collector layer 102 include conventional components for interconnecting cells to enable cell monitoring or sensing. For example, although not shown in FIG. 1, the current collector layer 102 may include a current collector array (or current collectors), a temperature sensor array (e.g., thermistors, etc.), an array of conductive sense lines, an array of resistive components (e.g., resistors, etc.), etc. In other examples, the current collector layer 102 may include additional components if desired.

In the example of FIG. 1, the electrically isolating layer 106 may be a sheet of electrically insulating material, such as plastic (e.g., fiberglass, etc.) In such examples, the electrically isolating layer 106 provides isolation between the cell stack and an environment outside the interconnect board 100. For example, in some applications, one or more layers of the interconnect board 100 and/or layers connected to the interconnect board 100 may deform and/or pull away due to applied forces. In such examples, the electrically isolating layer 106 effectively isolates the cell stack (e.g., the battery cells 118, 120 in FIG. 1) when the layers deform and/or pull away. As such, the electrically isolating layer 106 may both protect the battery cells 118, 120 from the outside environment and protect users from getting electrocuted (e.g., by touching the current collector layer).

As shown in FIG. 1, the adhesive layer 104 is disposed on and extends across the current collector layer 102. For example, adhesive may flow into, between, and/or through open areas in the current collector layer 102. In other words, the adhesive may use the porous natural of the current collector layer 102 to create a capillary action with respect to the current collector layer 102. Then, the adhesive may cure over time or be cured (e.g., thermally cured, etc.) to form the adhesive layer 104. With such characteristics, the adhesive layer 104 may self-level on the current collector layer 102, thereby providing a level surface layer on top of the non-level current collector layer 102.

In the example of FIG. 1, the adhesive layer 104 may be formed of any suitable type of adhesive. For example, the adhesive layer 104 may be a self-wicking adhesive material that may flow on and thorough the current collector layer 102. In other examples, the adhesive layer 104 may be a hot melt adhesive material that is poured onto the current collector layer 102 and then cured using any suitable mechanism, such as UV light.

The adhesive layer 108 is disposed on and extends across the electrically isolating layer 106. In such examples, the adhesive layer 108 may be formed of any suitable type of adhesive. For example, the adhesive layer 108 may include a flowable adhesive material that is cured after placement, a preformed sheet of adhesive, etc. In some examples, the adhesive layer 108 may connect to (e.g., adheres with) a shear plate of a battery module or battery pack.

In various embodiments, the interconnect board 100 may include an optional adhesive layer 110. In such examples, the adhesive layer 110 is generally disposed between the current collector layer 102 and the battery cells 118, 120. For example, in FIG. 1, the adhesive layer 110 may be disposed between the portion 112 of the current collector layer 102 and the battery cell 118 (e.g., the body 122) and between the portion 116 of the current collector layer 102 and the battery cell 120 (e.g., the body 124).

In some examples, the adhesive layer 110 may extend across some of the current collector layer 102. For example, the adhesive layer 110 may include a high viscosity adhesive material that can flow through porous areas of the current collector layer 102. In such examples, the adhesive material may settle along a bottom surface of the current collector layer 102, such as a bottom surface of the middle portion 114 in the current collector layer 102 as shown in FIG. 1. In other examples, an adhesive material may be dispensed on desired areas of the battery cells 118, 120 before the current collector layer 102 is applied. In either case, the adhesive material may be disposed in an overlapping area between the portions 112, 114 and the battery cell 118 and an overlapping area between the portions 114, 116 and the battery cell 120, as shown in FIG. 1. In other examples, the adhesive material may extend across the entire bottom surface of the middle portion 114 if desired.

In the example of FIG. 1, the adhesive layers 104, 108, 110 may have different adhesion strengths. In such examples, the adhesion strengths of the adhesive layers 104, 108, 110 may be modified in any suitable manner, such as using a different material, adding an additive (e.g., changing a formulation), etc.

For example, the adhesive layer 108 (e.g., the top adhesive layer) may have the lowest adhesion strength among the adhesive layers 104, 108, 110. In other words, an adhesion strength of the adhesive layer 108 may be less than an adhesion strength of the adhesive layer 104 and an adhesion strength of the adhesive layer 110. In such examples, the adhesive layer 108 having a smaller adhesion strength may deform and/or pull away from the electrically isolating layer 106 when a force is applied, as further explained below. Additionally, in some examples, the adhesive layer 104 (e.g., the middle adhesive layer) may have the highest adhesion strength among the adhesive layers 104, 108, 110. In other words, the adhesion strength of the adhesive layer 104 may be greater than the adhesion strength of the adhesive layer 108 and the adhesion strength of the adhesive layer 110. In such examples, the adhesive layer 104 having a larger adhesion strength may remain adhered to (e.g., not pull away) from the current collector when a force is applied, as further explained below. With the adhesive characteristics above, the adhesion strength of the adhesive layer 110 (e.g., the bottom adhesive layer) may be less than the adhesion strength of the adhesive layer 104 (e.g., the middle adhesive layer) and greater than the adhesion strength of the adhesive layer 108 (e.g., the top adhesive layer).

In some examples, the adhesion strengths among the adhesive layers 104, 108, 110 may be any suitable values as long as the adhesion strength of the adhesive layer 110 (e.g., the bottom adhesive layer) is less than the adhesion strength of the adhesive layer 104 (e.g., the middle adhesive layer) and greater than the adhesion strength of the adhesive layer 108 (e.g., the top adhesive layer). For example, the adhesion strengths of the adhesive layers 104, 108, 110 may be expressed in ratios. For instance, in some examples, the adhesion strengths for the adhesive layers 110, 104, 108 may follow the ratios 1:1.5:0.5, respectively. In other words, a ratio between the adhesion strengths for the adhesive layers 110, 104 may be 1:1.5, while a ratio between the adhesion strengths for the adhesive layers 110, 108 may be 1:0.5. Thus, again, the ratios exemplify that the adhesive layer 104 has the highest adhesion strength and the adhesive layer 108 has the lowest adhesion strength.

Additionally, in the example of FIG. 1, the interconnect board 100 may include one or more structural layers. In such examples, the additionally structural layers may provide structural support (e.g., a frame) for other layers, such as the current collector layer 102 while maintaining a flexible characteristic of the interconnect board 100. For example, and as shown in FIG. 1, the interconnect board 100 includes an upper flexible film layer 130 and a lower flexible film layer 132 disposed on opposing sides of the current collector layer 102. In such examples, the film layers 130, 132 may be any suitable material, such as flexible plastic material for protecting the current collector layer 102.

As shown in FIG. 1, the upper flexible film layer 130 and the lower flexible film layer 132 generally extend in parallel planes on opposing sides of the current collector layer 102. In such examples, the upper flexible film layer 130 and the lower flexible film layer 132 are generally disposed between the battery cells 118, 120. For example, in the FIG. 1, the upper flexible film layer 130 is disposed between the outer portions 112, 116 of the current collector layer 102 and between the rivets 126, 128 of the battery cells 118, 120. Additionally, the lower flexible film layer 132 is disposed between the bodies 122, 124 of the battery cells 118, 120.

In some examples, the film layers 130, 132 may form a laminate layer with the current collector layer 102. For example, the upper flexible film layer 130, the lower flexible film layer 132, and the current collector layer 102 may be laminated together. In such examples, the film layers 130, 132 function as a shrink wrap material that form along the current collector layer 102.

Additionally, in various embodiments, the interconnect board 100 may include one or more supplemental layers. For example, the interconnect board 100 may include a potting layer 134 disposed below the lower flexible film layer 132, and between the battery cells 118, 120, and more specifically the bodies 122, 124 of the battery cells 118, 120. In such examples, the potting layer 134 may be suitable material for protecting other layers in the interconnect board 100, such as the current collector layer 102. For example, the potting layer 134 may prevent water, moisture, corrosive agents, gases, etc. from intruding into the interconnect board 100, may absorb energy when a force is applied force, etc.

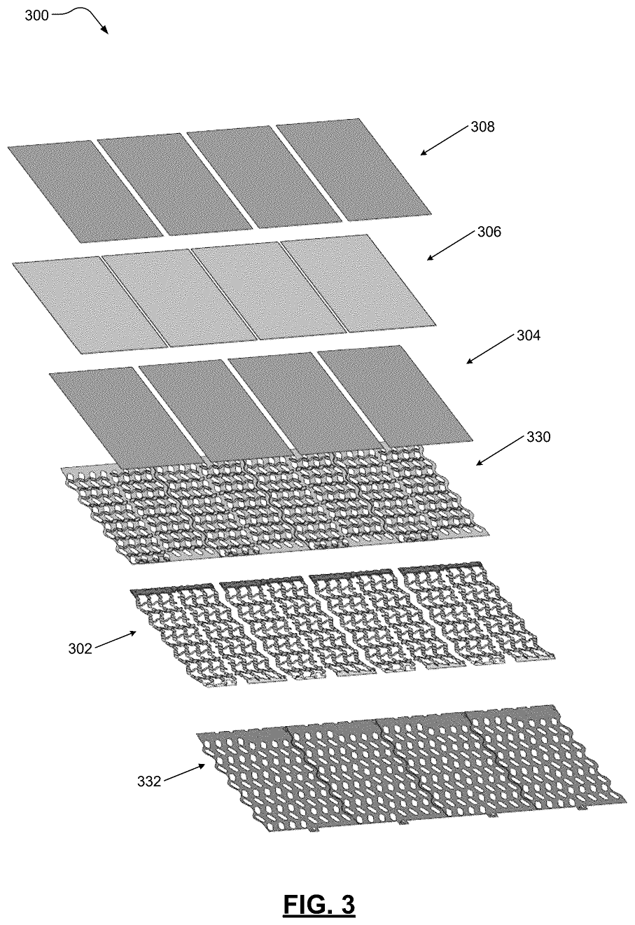

In various embodiments, the interconnect board 100 may be connected to or include one or more plates, such as shear plates. For example, FIG. 2 illustrates a portion of a battery module 200 including the interconnect board 100 of FIG. 1 and two shear plates disposed on opposing sides of the interconnect board 100. For example, in FIG. 1, the battery module 200 includes the interconnect board 100 with the current collector layer 102, the adhesive layers 104, 108, 110, the electrically isolating layer 106, the flexible film layers 130, 132, and the potting layer 134 of FIG. 1. As explained above, the current collector layer 102 includes the outer portions 112, 116 and the middle portion 114 extending in different planes. With this configuration, the outer portions 112, 116 contact the rivets 126, 128 of the battery cells 118, 120, and the middle portion 114 extends between the battery cells 118, 120 (and below the outer portions 112, 116).

As shown in FIG. 2, the battery module 200 further includes an upper shear plate 240 and a lower shear plate 250 disposed on opposing sides of the battery cells 118, 120. In such examples, the upper shear plate 240 and/or the lower shear plate 250 may deform and/or pull away when an external force is applied to the battery module 200, as further explained below. In some examples, the lower shear plate 250 may be considered a busbar holding tray for providing a smooth bonding surface for the interconnect board 100.

In the example of FIG. 2, the upper shear plate 240 is connected to (e.g., adhered to) the adhesive layer 108. Additionality, the lower shear plate 250 is connected to the battery cells 118, 120 and the potting layer 134 via one or more adhesive layers. For example, in FIG. 2, the battery cells 118, 120 may be connected to (e.g., adhered to) the lower shear plate 250 via adhesive layers 242, 244, while the potting layer 134 may be connected to (e.g., adhered to) the lower shear plate 250 via an adhesive layer 246. In such examples, the adhesive layers 242, 244 may have a similar adhesion strength (e.g., a low or weak adhesive bond) as the adhesive layer 108, and the adhesive layer 246 may have a higher adhesion strength than the adhesive layers 242, 244. In other examples, the lower shear plate 250 may be connected to the battery cells 118, 120 and the potting layer 134 via a single adhesive layer.

FIG. 3 depicts an exploded view of an interconnect board assembly 300. In the example of FIG. 3, the interconnect board assembly 300 generally includes similar layers as the interconnect board 100 of FIG. 1. For example, the interconnect board 100 of FIG. 1 may be a portion of the interconnect board assembly 300 shown in FIG. 3. As shown in FIG. 3, the interconnect board assembly 300 of FIG. 3 includes a current collector layer 302, upper and lower flexible film layers 330, 332 (e.g., laminate sheets) disposed on opposing sides of the current collector layer 302, an adhesive layer 304 disposed on the current collector layer 302, an electrically isolating layer 306 disposed on the adhesive layer 304, and an adhesive layer 308 disposed on the electrically isolating layer 306.

In the example of FIG. 3, the current collector layer 302 continuously connects various battery cells, such as the battery cells 118, 120 of FIG. 1. For example, the current collector layer 302 includes a repeating pattern of a square wave configuration formed of outer portions (e.g., the outer portions 112, 116 of FIG. 1) and middle portions (e.g., the middle portion 114 of FIG. 1) extending in different planes. In such examples, each outer portion set contacts a pair of adjacent battery cells, as explained above relative to FIG. 1. With this continuous arrangement, the current collector layer 302 (along with the flexible film layers 330, 332 laminated with the current collector layer 302) may form Z stack configuration with the battery cells of a battery.

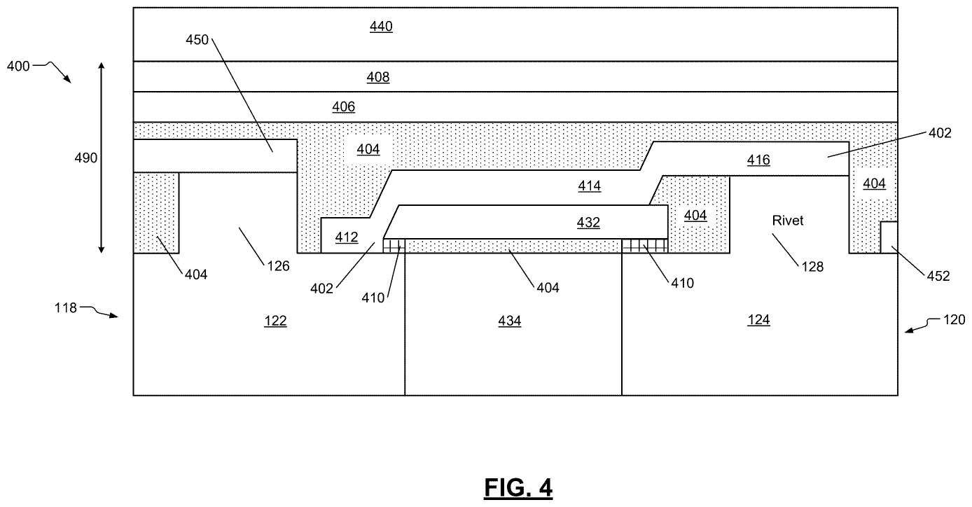

In various embodiments, other interconnect boards herein may include more or less layers and/or a different stack configuration than the interconnect board 100 of FIG. 1. For example, FIG. 4 depicts an example interconnect board 400 for providing cell monitoring in a BMS. As shown in FIG. 4, the interconnect board 400 generally includes a current collector layer 402, adhesive layers 404, 408, 410, an electrically isolating layer 406, and a potting layer 434. As shown, the adhesive layer 404 (shown with a dot cross-hatching) is disposed on the current collector layer 402, the electrically isolating layer 406 is disposed on the adhesive layer 404, the adhesive layer 408 is disposed on the electrically isolating layer 406, and the adhesive layer 410 (shown with a grid cross-hatching) is generally disposed between the current collector layer 402 and the battery cells 118, 120.

In this example of FIG. 4, the current collector layer 402, the adhesive layers 404, 408, 410, the electrically isolating layer 406, and the potting layer 434 generally include the same materials and/or functions as the current collector layer 102, the adhesive layers 104, 108, 110, the electrically isolating layer 106, and the potting layer 134, respectively, of FIG. 1.

For example, the adhesive layers 404, 408, 410 may have different adhesion strengths. For instance, the adhesive layer 408 (e.g., the top adhesive layer) has the lowest adhesion strength among the adhesive layers 404, 408, 410, and the adhesive layer 404 (e.g., the middle adhesive layer) has the highest adhesion strength among the adhesive layers 404, 408, 410. The adhesion strength of the adhesive layer 410 (e.g., the bottom adhesive layer) is less than the adhesion strength of the adhesive layer 404 (e.g., the middle adhesive layer) and greater than the adhesion strength of the adhesive layer 408 (e.g., the top adhesive layer). In some examples, the adhesion strengths for the adhesive layers 410, 404, 408 may follow the ratios 1:1.5:0.5, respectively, as explained above or another suitable ratios.

In such examples, due to the differing adhesion strengths, each adhesive layer 404, 408, 410 may react differently when a force is applied. For example, the adhesive layer 408 having a smaller adhesion strength may deform and/or pull away from the electrically isolating layer 406 while the adhesive layer 404 having a larger adhesion strength may remain adhered to (e.g., not pull away) from the current collector 402 when a force is applied, as further explained below.

Additionally, the similar to the adhesive layer 104 of FIG. 1, the adhesive layer 404 may include a type of curable adhesive (e.g., a self-wicking adhesive material, a hot melt adhesive material, etc.) that flows into, between, and/or through open areas in the current collector layer 402. In other words, the adhesive may use the porous natural of the current collector layer 402 to create a capillary action with respect to the current collector layer 402, as explained above. As such, the adhesive layer 104 may be disposed generally around the current collector layer 402, including on the current collector layer 402, below the current collector layer 402, etc. as shown in FIG. 4. With this flowability and capillary action of the current collector layer 402, the adhesive layer 104 is able to self-level on the current collector layer 402, thereby providing a level surface layer on top of the non-level current collector layer 402, as shown in FIG. 4.

Additionally, similar to the current collector layer 102 of FIG. 1, the current collector layer 402 includes multiple portions 412, 414, 416 each extending in a longitudinal direction. In this example, the portion 414 (e.g., a middle portion) extends between the portions 412, 416 (e.g., outer portions). The portions 412, 414, 416 are connected together via portions extending generally traverse to the portions 412, 414, 416. In various embodiments, the current collector layer 102 may be integrally formed as a single piece, as shown in FIG. 4.

The outer portions 412, 416 of the current collector layer 402 connect with the battery cells 118, 120. Specifically, in FIG. 4, the outer portion 412 of the current collector layer 402 connects to a top portion (or positive terminal) of the battery cell 118. Likewise, the outer portion 416 of the current collector layer 402 connects to the rivet 128 (or positive terminal) of the battery cell 118.

Additionally, and as shown in FIG. 4, the middle portion 414 extends in a different plane than the outer portions 4112, 416. For example, in FIG. 4, the portions 412, 414, 416 extend in parallel planes. However, the middle portion 414 extends in a plane offset from each outer portion 412, 416. For instance, in FIG. 4, the middle portion 414 extends in a plane positioned between the outer portions 412, 416 (or planes thereof). In other words, the middle portion 414 extends in a plane above the outer portion 412 and below the outer portion 416. With this configuration, the portions 412, 414, 416 generally form a Z shaped configuration with the battery cells 118, 120.

In various embodiments, the interconnect board 400 may further include one or more structural layers for providing structural support (e.g., a frame) to other layers, such as the current collector layer 402 while maintaining a flexible characteristic of the interconnect board 400. In such examples, the structural layer(s) may be any suitable material, such as flexible plastic material for protecting the current collector layer 402. For example, in FIG. 4, the interconnect board 400 includes a flexible film layer 432 generally disposed below the current collector layer 402 (or portions thereof) and between the current collector layer 402 and the battery cells 118, 120. More specifically, the flexible film layer 432 is disposed below the middle portion 414 of the current collector layer 402 and between the rivets 126, 128 of the battery cells 118, 120.

In some examples, the film layer 432 may form a laminate layer with the current collector layer 402. In such examples, the film layer 432 may function as a shrink wrap material that forms along a bottom surface of the current collector layer 402.

In the example of FIG. 4, the interconnect board 400 may represent a portion of a larger interconnect board for providing cell monitoring across numerous battery cells in a BMS. As such, it should be appreciated that the interconnect board 400 may include multiple current collector layers for connecting with different battery cells of the battery module or pack. In such examples, each current collector layer may include the same configuration as the current collector layer 402 having the outer portion 412 (e.g., a lower outer portion), the outer portion 416 (e.g., an upper outer portion), and the middle portion 414. For example, and as shown in FIG. 4, the interconnect board 400 includes a portion (e.g., an upper outer portion) of a current collector layer 450 connected to the rivet 126 of the battery cell 118 and a top portion (or positive terminal) of another battery cell (not shown) adjacent the battery cell 118. Additionally, the interconnect board 400 includes a portion (e.g., a lower outer portion) of a current collector layer 452 connected to a top portion (or positive terminal) of the battery cell 120 and a rivet of another battery cell (not shown) adjacent the battery cell 120.

As shown in FIG. 4, the interconnect board 400 connects with an upper shear plate 440. More specifically, the upper shear plate 440 is connected to (or adhered to) the adhesive layer 408. In such examples, the upper shear plate 440 may deform and/or pull away when an external force is applied, as further explained below. While FIG. 4 only illustrates the upper shear plate 440, it should be appreciated that the interconnect board 400 may also connect with a lower shear plate, such as the lower shear plate 250 of FIG. 2.

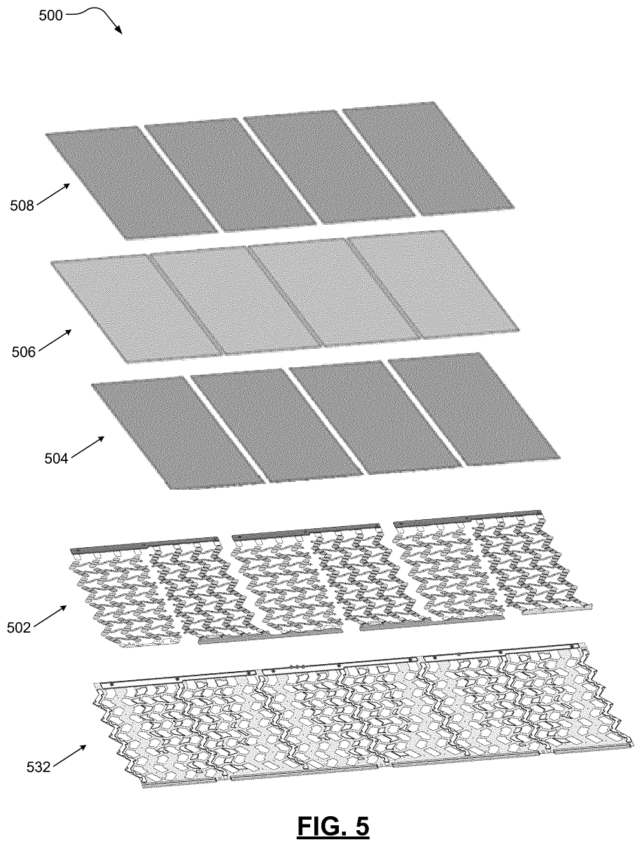

FIG. 5 depicts an exploded view of an interconnect board assembly 500 including similar layers as the interconnect board 400 of FIG. 4. For example, the interconnect board 400 of FIG. 4 may be a portion of the interconnect board assembly 500 shown in FIG. 5. As shown in FIG. 5, the interconnect board assembly 500 of FIG. 5 includes a current collector layer 502, a flexible film layer 532 (e.g., a laminate sheet) disposed on a bottom side of the current collector layer 502, an adhesive layer 504 disposed on at least a top side of the current collector layer 502, an electrically isolating layer 506 disposed on the adhesive layer 504, and an adhesive layer 508 disposed on the electrically isolating layer 506. The material of the adhesive layer 504 may flow into, between, and/or through open areas in the current collector layer 502 as explained herein.

In the example of FIG. 5, the current collector layer 502 continuously connects various battery cells, such as the battery cells 118, 120 of FIG. 4. For example, the current collector layer 502 includes a repeating pattern of outer portions (e.g., the outer portions 412, 416 of FIG. 4) and middle portions (e.g., the middle portion 414 of FIG. 4) extending in different planes for connecting with adjacent pairs of battery cells. With this continuous arrangement, the current collector layer 502 (along with the flexible film layer 532 laminated with the current collector layer 502) may form Z stack configuration with the battery cells of a battery module.

The interconnect boards and assemblies herein provide a low-profile cell sensing support with significant packaging, mass, and GD&T advantages over convention frames, such as injection molded frames. For example, the interconnect boards and assemblies may have a profile or width significantly less than convention frames. In some examples, the width of any one of the interconnect boards and assemblies herein may be less than half the width of a convention frame. For instance, the interconnect board 400 of FIG. 4 may have a width (indicated by an arrow 490) of less than 3.5 mm. This reduced profile results in a significant reduction in packaging and mass (e.g., reduced weight).

Additionally, the interconnect boards and assemblies herein adapt a non-structural cell sensing configuration for a structural pack environment. For example, through the use of adhesive layers with different strengths, a non-structural cell sensing configuration may be achieved. With this approach of using a lower strength adhesive (e.g., as compared to a higher strength adhesive) at a shear plate-to-isolation sheet interface, load decoupling under excessive intrusion may be allowed.

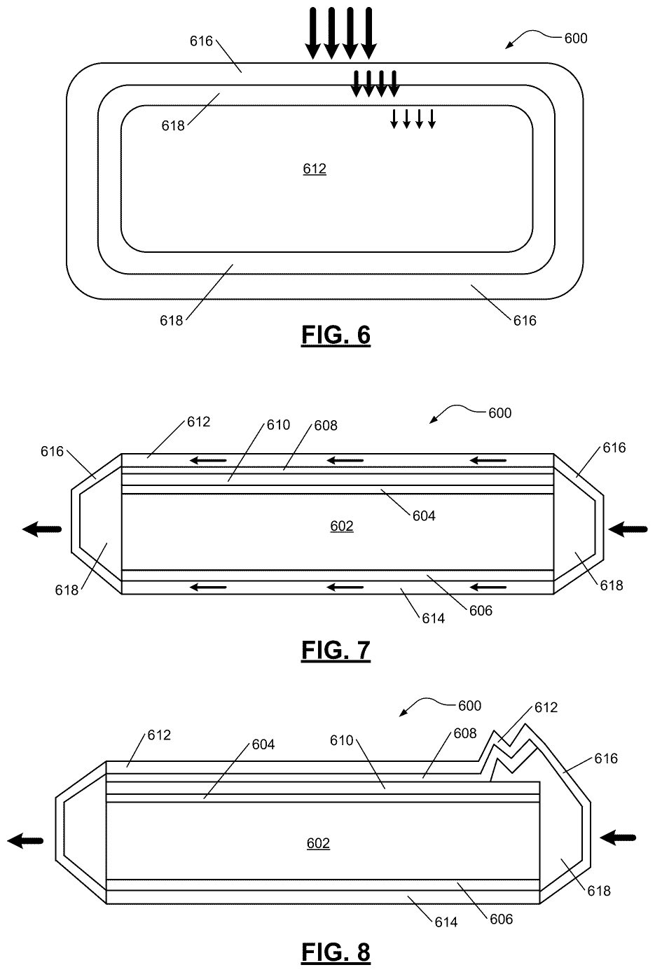

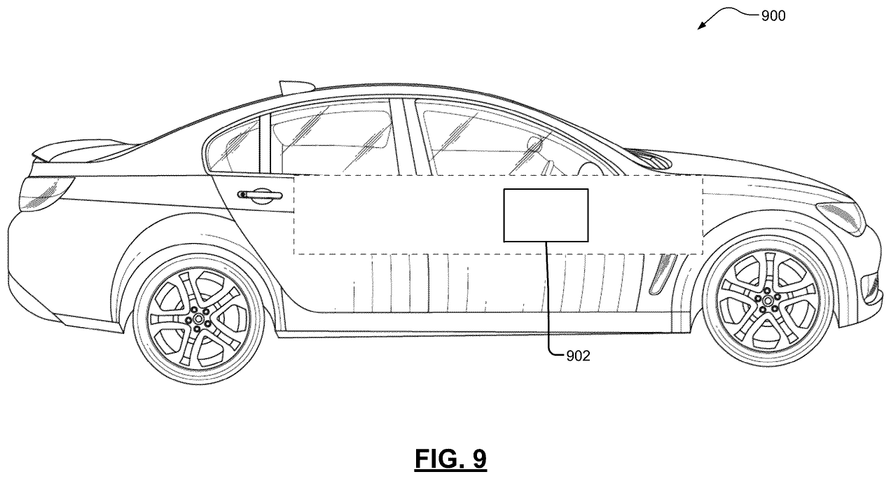

For example, FIGS. 6-8 depict a portion of a battery module 600. FIG. 6 illustrates a top view of the battery module 600 while FIGS. 7-8 depict side views of the battery module 600. As shown, the battery module 600 generally includes a battery cell stack 602, adhesion interfaces 604, 606, 608, a portion of an interconnect board assembly 610, shear plates 612, 614, a basin 616, and a potting layer 618. The shear plate 612 is connected to the interconnect board assembly 610 via the adhesion interface 608, and the shear plate 614 is connected to the battery cell stack 602 via the adhesion interface 606.

In this example, the adhesion interfaces 604, 606 and the interconnect board assembly 610 may be part of any one of the interconnect board assemblies herein. For example, the adhesion interface 604 may be similar to the adhesive layers 104, 404 of FIGS. 1 and 4, and the adhesion interface 608 may be similar to the adhesive layers 108, 408 of FIGS. 1 and 4. As such, the adhesion interface 608 (e.g., the top adhesive layer) has a lower adhesion strength as compared to the other adhesive interfaces, and the adhesion interface 604 (e.g., the middle adhesive layer) has a higher adhesion strength as compared to the other adhesive interfaces.

As shown, the potting layer 618 is positioned between the basin 616 (e.g., structural support) and a stack formed of the interconnect board assembly 610 and the battery cell stack 602. With this configuration, a load (e.g., a force) applied to the battery module 600 may be reduced as the load passes through the battery module 600. For example, the basin 616 and the potting layer 618 (e.g., with foam stuffers) may absorb energy of the applied load, thereby effectively reducing the amount of load passing through the battery module 600. A magnitude of the load passing through the battery module 600 is shown in FIG. 6 by sets of arrows with decreasing size (representing the decreasing load).

A similar scenario is presented in FIG. 7. For example, in FIG. 7, a load is applied to the basin 616. This load may originate from, for example, a collision with a vehicle having the battery module 600. As shown in FIG. 7, the load (represented by arrows) can be transferred from one side of the basin 616, through the shear plates 612, 614, and out of the other side of the basin 616. Such load transferring may occur, for example, when the applied load is relatively small.

However, FIG. 8 depicts a failsafe scenario that may occur when the applied load is increased. For example, when the load (represented by an incoming arrow) is applied to the basin 616, the shear plate 612 and the adhesion interface 608 deforms and pulls away from the interconnect board assembly 610. This is due to, for example, the lower adhesion strength of the adhesion interface 608. Importantly, the interconnect board assembly 610 remains intact due to, for example, the higher adhesion strength of the adhesion interface 604, thereby protecting the battery cell stack 602. As such, due to the differing adhesion strengths of the adhesion interfaces 604, 608, a staged separation of the interconnect board assembly 610 may be achieved based on the intrusion severity realized by the applied load.

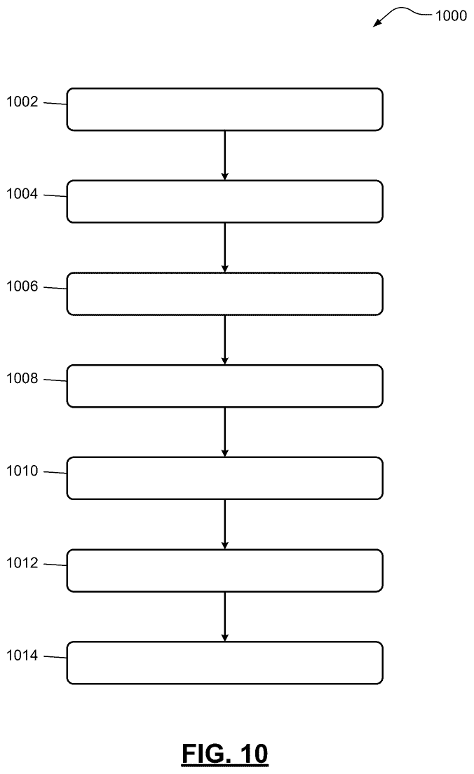

The interconnect boards and assemblies herein may be employed in any suitable battery module or battery pack. Additionally, the battery module or battery pack may be employed in vehicles implementations or non-vehicles implementations. If employed in a vehicle implementation, the interconnect boards and assemblies herein may be used with high voltage battery packs. In such examples, the vehicle may be an electric vehicle (e.g., a pure electric vehicle, a hybrid electric vehicle, etc.), an autonomous vehicle (e.g., a fully or semi-autonomous vehicle), etc. As one example, FIG. 9 depicts a vehicle 900 including a battery module 902 which may include any one of the interconnect boards and assemblies herein.

FIG. 10 illustrates an example process 1000 for manufacturing an interconnect board stack, such as the interconnect board 100 of FIG. 1 and the interconnect board 400 of FIG. 4. As shown in FIG. 10, the process 1000 begins by at 1002 by preparing a cell stack. For example, multiple battery cells (e.g., the battery cells 118, 120) may be arranged in a group, an array, etc. In such examples, the battery cells or cell groups may be coupled in series and/or parallel configurations to obtain different high voltages. The process 1000 then proceeds to 1004.

At 1004, an optional adhesive layer is dispensed. For example, adhesive, such as a high viscosity adhesive may be dispensed on a top surface of each battery cell (e.g., a portion of each cell body). The dispensed adhesive may cure over time or be cured (e.g., thermally cured, etc.) to form an adhesive layer, such as the adhesive layer 110 of FIGS. 1-2 or the adhesive layer 410 of FIG. 4. In such examples, the adhesive layer may be considered an anchoring adhesive. The process 1000 then proceeds to 1006.

At 1006, an interconnect board assembly is installed. For example, the interconnect board assembly may include a current collector layer and one or more flexible film layers laminated together. For stance, the interconnect board assembly may include the current collector layer 102 of FIGS. 1-2 and the opposing flexible film layers 130, 132 of FIGS. 1-2 laminated together. In other examples, the interconnect board assembly may include the current collector layer 402 of FIG. 4 and the flexible film layer 432 of FIG. 4 laminated together. Regardless of the interconnect board assembly employed, the current collector layer is attached (e.g., welded, etc.) to terminals of the battery cells (e.g., rivets and/or can bodies of the battery cells). The process 1000 then proceeds to 1008.

At 1008, an adhesive layer is dispensed above the interconnect board assembly. For example, adhesive, such as a high viscosity adhesive may flow into, between, and/or through open areas in the interconnect board assembly (e.g., in the current collector layer 102, the current collector layer 402, etc.), as explained above. Then, the adhesive may be cured to form the adhesive layer, such as the adhesive layer 104 of FIGS. 1-2, the adhesive layer 404 of FIG. 4, etc. In such examples, the adhesive layer may self-level on the interconnect board assembly, thereby providing a level surface layer. In this example, the adhesive layer dispensed in 1008 has a higher adhesion strength than the adhesive layer dispensed in 1004. The process 1000 then proceeds to 1010.

At 1010, an isolation layer is installed. For example, any suitable electrically isolating layer, such as the electrically isolating layer 106 of FIGS. 1-2, electrically isolating layer 406 of FIG. 4 may be disposed on the adhesive layer dispensed in 1008. In such examples, the isolation layer may be one or more sheets of electrically insulating material, such as fiberglass. In such examples, after the isolation layer is placed on the adhesive layer, pressure may be applied for a period of time to connect the isolation layer and the adhesive layer together. The process 1000 then proceeds to 1012.

At 1012, another adhesive layer is dispensed above the isolation layer. In such examples, the adhesive may be dispensed on the isolation layer and then cured to form the adhesive layer, such as the adhesive layer 108 of FIGS. 1-2, the adhesive layer 408 of FIG. 4, etc. In this example, the adhesive layer dispensed in 1012 has a lower adhesion strength than the adhesive layer dispensed in 1004 and the adhesive layer dispensed in 1008. The process 1000 then proceeds to 1014.

At 1014, a shear plate is installed on the adhesive layer dispensed in 1012. In such examples, after the shear plate is placed on the adhesive layer, pressure may be applied for a period of time to connect the shear plate and the adhesive layer together. The process 1000 may then end.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is

1. An interconnect board for connecting between a plurality of battery cells of a battery module, the interconnect board comprising:
a current collector layer including a first portion configured to connect to a first battery cell of the battery module, a second portion configured to connect to a second battery cell of the battery module, and a third portion between the first portion and the second portion, wherein the first portion and the second portion extend in a first plane and the third portion extends in a second plane different than the first plane;
a first adhesive layer disposed on the current collector layer;
an electrically isolating layer disposed on the first adhesive layer; and
a second adhesive layer disposed on the electrically isolating layer and configured to connect to a shear plate of the battery module.

2. The interconnect board of claim 1, wherein the third portion of the current collector layer extends between the first battery cell and the second battery cell.

3. The interconnect board of claim 1, further comprising an upper flexible film layer and a lower flexible film layer disposed on opposing sides of the current collector layer.

4. The interconnect board of claim 3, wherein the upper flexible film layer, the lower flexible film layer, and the current collector layer are laminated together.

5. The interconnect board of claim 1, further comprising a flexible film layer disposed between the current collector layer and the first battery cell and the second battery cell of the battery module.

6. The interconnect board of claim 1, wherein the first adhesive layer is configured to self-level on the current collector layer.

7. The interconnect board of claim 6, wherein an adhesion strength of the second adhesive layer is less than an adhesion strength of the first adhesive layer.

8. The interconnect board of claim 7, further comprising a third adhesive layer disposed between the first portion of the current collector layer and the first battery cell of the battery module, and between the second portion of the current collector layer and the second battery cell of the battery module.

9. The interconnect board of claim 8, wherein an adhesion strength of the third adhesive layer is less than the adhesion strength of the first adhesive layer and greater than the adhesion strength of the second adhesive layer.

10. The interconnect board of claim 9, wherein the interconnect board has a width of less than 3.5 mm.

11. The interconnect board of claim 10, wherein the current collector layer forms a Z stack configuration with the plurality of battery cells of the battery module.

12. A battery module for a vehicle, the battery module comprising:
a plurality of battery cells including at least a first battery cell and a second battery cell; and
an interconnect board for connecting between the plurality of battery cells, the interconnect board including:
a current collector layer including a first portion connected to the first battery cell, a second portion connected to the second battery cell, and a third portion between the first portion and the second portion, wherein the third portion extends in a plane different than the first portion and the second portion;
an electrically isolating layer configured to isolate the plurality of battery cells;
a first adhesive layer disposed between the current collector layer and the electrically isolating layer;
a second adhesive layer disposed on a side of the electrically isolating layer opposing the first adhesive layer; and
a third adhesive layer disposed between the first portion of the current collector layer and the first battery cell of the battery module and between the second portion of the current collector layer and the second battery cell of the battery module.

13. The battery module of claim 12, further comprising a shear plate connected to the second adhesive layer, wherein the shear plate and the second adhesive layer are configured to deform in response to an applied force without damaging the plurality of battery cells.

14. The battery module of claim 12, wherein the first adhesive layer is configured to self-level on the current collector layer.

15. The battery module of claim 14, wherein the interconnect board includes an upper flexible film layer and a lower flexible film layer disposed on opposing sides of the current collector layer, and wherein the upper flexible film layer, the lower flexible film layer, and the current collector layer are laminated together.

16. The battery module of claim 14, wherein the interconnect board includes a flexible film layer disposed between the current collector layer and the first battery cell and the second battery cell of the battery module.

17. The battery module of claim 12, wherein an adhesion strength of the second adhesive layer is less than an adhesion strength of the first adhesive layer.

18. The battery module of claim 17, wherein an adhesion strength of the third adhesive layer is less than the adhesion strength of the first adhesive layer and greater than the adhesion strength of the second adhesive layer.

19. The battery module of claim 12, wherein the interconnect board has a width of less than 3.5 mm.

20. A battery module for a vehicle, the battery module comprising:
a plurality of battery cells including at least a first battery cell and a second battery cell;
an upper shear plate and a lower shear plate disposed on opposing sides of the plurality of battery cells; and
an interconnect board for connecting between the plurality of battery cells, the interconnect board including:
a current collector layer including a first portion connected to the first battery cell, a second portion connected to the second battery cell, and a third portion extends between the first battery cell and the second battery cell;
an electrically isolating layer configured to isolate the plurality of battery cells;
a first adhesive layer disposed between the current collector layer and the electrically isolating layer;
a second adhesive layer disposed between the electrically isolating layer and the upper shear plate; and
a third adhesive layer disposed between the first portion of the current collector layer and the first battery cell of the battery module and between the second portion of the current collector layer and the second battery cell of the battery module,
wherein an adhesion strength of the second adhesive layer is less than an adhesion strength of the first adhesive layer, and wherein an adhesion strength of the third adhesive layer is less than the adhesion strength of the first adhesive layer and greater than the adhesion strength of the second adhesive layer.
